(19) United States
(12) Patent Application Publication
(10) Pub. No.: US 2026/0242203 A1
(43) Pub. Date: Aug. 20, 2026

(54) VALVE ASSEMBLY FOR A BEVERAGE KEG

(71) Applicant: Steve SALCEDO, Canton, CT (US)

(72) Inventor: Steve SALCEDO, Canton, CT (US)

(21) Appl. No.: 19/543,478

(22) Filed: Feb. 18, 2026

Related U.S. Application Data
(60) Provisional application No. 63/759,673, filed on Feb. 18, 2025.

(51) Int. Cl. B67D 1/08; B67D 1/14

(52) U.S. Cl. CPC B67D 1/0838; B67D 1/0808; B67D 1/0829; B67D 1/0831; B67D 1/0835; B67D 1/1455

(57) ABSTRACT

An assembly for coupling to a barnes neck of a beverage keg includes a housing defining a chamber along a center axis and a coupler at the bottom end having a C-shaped cross-section to receive the barnes neck. A probe is moveable along the axis. An umbrella seal positioned about a bottom portion of the probe creates a seal around the keg valve during use and prevents overspray during disengagement. A handle extends into the chamber and pivots about a transverse axis, with at least one engagement foot positioned above the umbrella seal to move the probe and seal axially between engaged and disengaged positions. In the engaged position, the probe opens the keg valve to permit beverage flow through the valve and gas flow into the keg; in the disengaged position, the probe is spaced from the valve to prevent beverage and gas flow.

### CROSS-REFERENCE TO RELATED APPLICATIONS

The present application claims priority to U.S. Provisional Patent Application Ser. No. 63/759,673, filed Feb. 18, 2025 and entitled “VALVE ASSEMBLY FOR A BEVERAGE KEG,” the entirety of which is incorporated by reference herein.

### FIELD OF THE DISCLOSURE

The present disclosure relates to valve assemblies for beverage kegs.

### BACKGROUND

This section provides background information related to the present disclosure which is not necessarily prior art.

Beverage kegs are widely used for the storage and dispensing of liquid products, particularly carbonated beverages such as beer. Among the various keg designs, well-style kegs are prominent due to their robust construction, ease of handling, and compatibility with modern dispensing systems. As shown in FIG. 1, these kegs 1 typically include a recessed well 2 at the top, which houses a keg valve 3 (e.g., a spear valve 3) and provides additional protection for critical components during transportation and use. The keg valve 3 includes a ball 11 and seal 12 that are compressed upwardly against a valve seat 13.

Central to the functionality of well-style kegs 1 is the barnes neck 4, a cylindrical extension that forms the interface between the body 5 of the keg 1 and a dispensing valve assembly 6. This assembly is configured to emit compressed gas into the keg 1 and extract the beverage from it. The barnes neck 4 is critical for securing the dispensing valve assembly 6 and ensuring an airtight seal. It is typically designed to accommodate specific coupling systems of the valve assembly 6, allowing for a reliable connection to beverage dispensing equipment.

Three common coupling systems of dispensing valve assemblies 6 used with well-style kegs are D-style, S-style and U-style couplers. An example of a D-style coupler 7 is shown in FIGS. 2 and 3. The D-style coupler 7, also known as the “American Sankey,” is widely used in North America and features a single probe 8 that engages with the keg valve 3 in response to movement of a handle in response to movement of a handle to allow the flow of gas into and out of the keg 1. The S-style coupler, commonly referred to as the “European Sankey,” is similar in design but features a slightly longer probe, making it suitable for kegs with deeper keg valve configurations. The U-style coupler, often used with certain United Kingdom and Irish brewery kegs, has a shorter probe and slightly wider body than the other two styles. All coupler styles rely on standardized dimensions to ensure compatibility with kegs and dispensing equipment across different manufacturers.

All of these systems include a tapered cam track 9 on the coupler 7, which receives a cam 10 built into the barnes neck 4, sealing the coupler 7 to the barnes neck 4. A handle 11 of the coupler 7 is actuated to cause the probe 8 to move the ball 11 and seal 12 donwardly relative to the valve seat 13, opening the keg valve 3 to enable compressed gas to enter the keg 1 through the keg valve 3 from the dispensing valve assembly 6, and to permit the beverage to be extracted from the keg through the keg valve 3 and dispensing valve assembly 6.

Certain issues are present with this style of keg 1. For instance, the specifications of the cam track 9 can differ from manufacturer to manufacturer. Oversized cam tracks 9 make engaging and disengaging the coupler 7 challenging for the end user and often result in lost beer sales to the establishment when staff cannot properly change over an empty keg 1. Furthermore, when a coupler 7 is too tight, it can cause the keg valve 3 to spin out of the keg 1 with the dispensing valve 7, resulting in additional work at the brewery level before the keg 1 can be sanitized and refilled.

Accordingly, there remains a need for improvements to dispensing valve assemblies for kegs.

### SUMMARY OF THE DISCLOSURE

According to an aspect of the disclosure, a dispensing valve assembly for being coupled with a barnes neck of a well-style beverage keg includes a housing that extends about and along a center axis between a top end and a bottom end and defines a chamber. A coupler is located at the bottom end of the housing. The coupler has a C-shaped cross-section and spans at least partially around the bottom end of the housing for receiving the barnes neck of the beverage keg. A probe is located in the chamber of the housing and is moveable along the center axis relative to the housing. An umbrella seal is positioned about a bottom portion of the probe for creating a seal about the keg valve during use of the dispensing valve assembly and for preventing overspray during disengagement of the coupler from the keg. A handle extends into the chamber of the housing and is pivotable relative to the housing about a pivot axis. The handle has at least one engagement foot positioned above the umbrella seal for moving the probe and umbrella seal axially up and down between an engaged position and a disengaged position in response to pivoting of the handle. The probe opens the keg valve when in the engaged position to permit the beverage in the keg to flow through the keg valve and to permit gas to flow into the keg, and the probe is axially spaced from the keg valve when in the disengaged position to prevent the beverage in the keg to flow through the keg valve, and to prevent the gas from flowing into the keg.

The dispensing valve assembly efficiently extracts the beverage from the well-style keg while preventing sealing and leakage issues, notably during disconnection of the valve assembly from the barnes neck. The design operates with existing kegs and keg valves without requiring modifications due to the arrangement of the coupler which fits about a top of the barnes neck. The dispensing valve assembly transitions smoothly between engaged and disengaged positions and is simple and inexpensive to assemble, notably due to the arrangement of the handle which pivots relative to the housing.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is a perspective view of a top portion of a conventional well-style beverage keg;

FIG. 2 is a perspective view of a conventional D-style tap coupler being connected to the beverage keg;

FIG. 3 is a perspective view of the D-style tap coupler connected to the beverage keg;

FIG. 4 is a top, perspective view of an embodiment of a dispensing valve assembly for a keg, according to an aspect of the disclosure;

FIG. 5 is a bottom, perspective view of the dispensing valve assembly;

FIG. 6 is an exploded, perspective view of the dispensing valve assembly;

FIG. 7 is a top, perspective view of an air intake assembly, handle and probe of the dispensing valve assembly;

FIG. 8 is a bottom view of a housing and handle of the dispensing valve assembly;

FIG. 9 is a side, cross-sectional view of the dispensing valve assembly, illustrating a probe of the dispensing valve assembly in a disengaged position;

FIG. 10 is a side, cross-sectional view of the dispensing valve assembly, illustrating the probe of the dispensing valve assembly in an engaged position;

FIG. 11 is a top, perspective view of the dispensing valve assembly being slid over a barnes neck of a beverage keg; and

FIG. 12 is a top, perspective view of the dispensing valve assembly coupled to the barnes neck of the beverage keg.

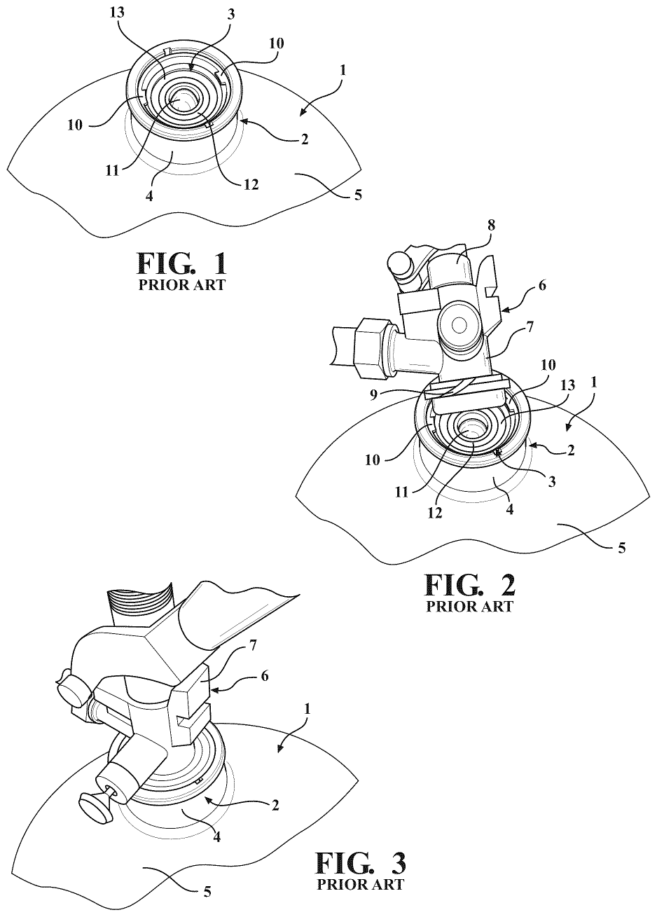

### DESCRIPTION OF THE ENABLING EMBODIMENT

Example embodiments will now be described more fully with reference to the accompanying drawings. In general, the subject embodiments are directed to a dispensing valve assembly 15 for a beverage keg 1, however the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

More particularly, referring to the figures, wherein like numerals indicate corresponding parts throughout the several views, embodiments of a dispensing valve assembly 15 for being coupled with a barnes neck 4 of a well-style beverage keg 1 are provided.

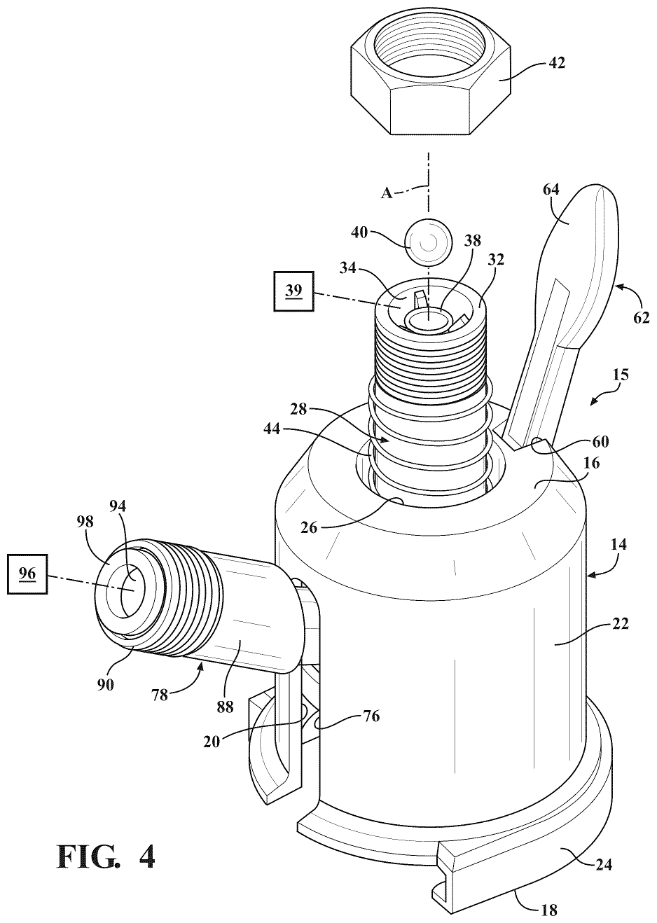

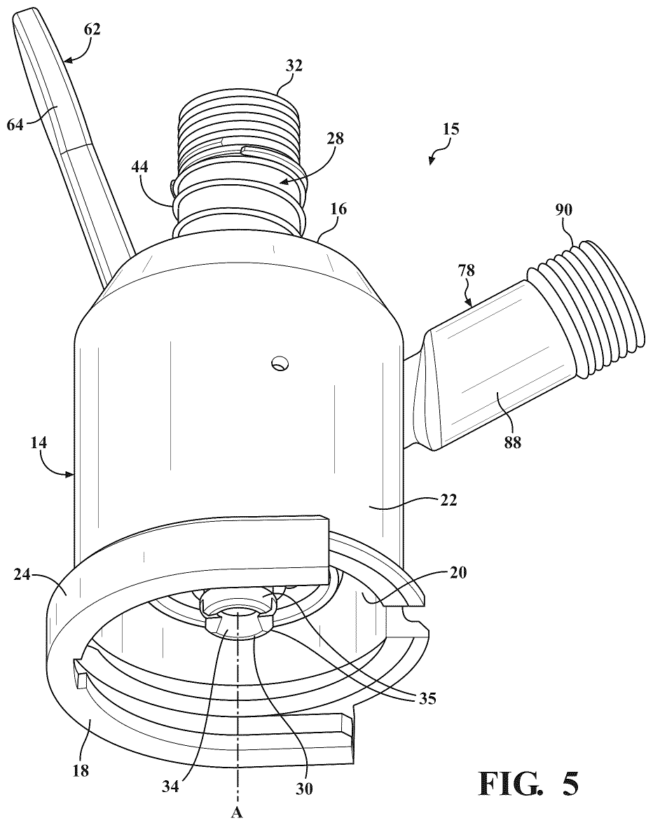

As best shown in FIGS. 4-5, the dispensing valve assembly 15 includes a generally bell-shaped housing 14 that extends about and along a center axis A between a top end 16 and a bottom end 18, and defines a chamber 20. The housing 14 has a wall 22 that extends between the top and bottom ends 16, 18.

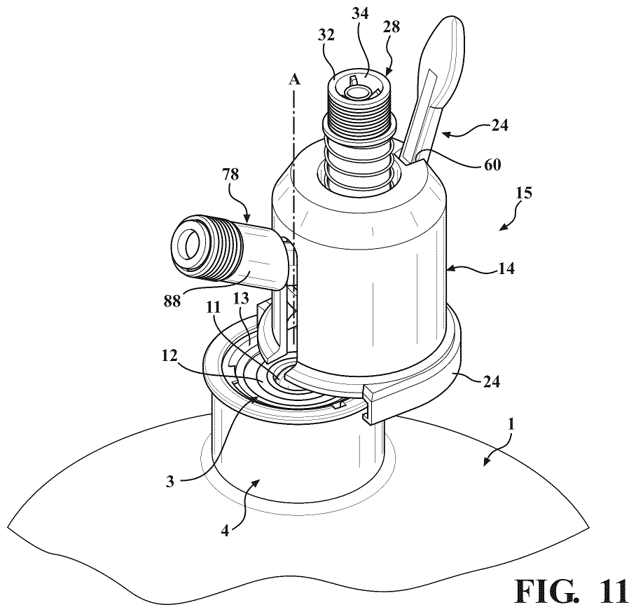

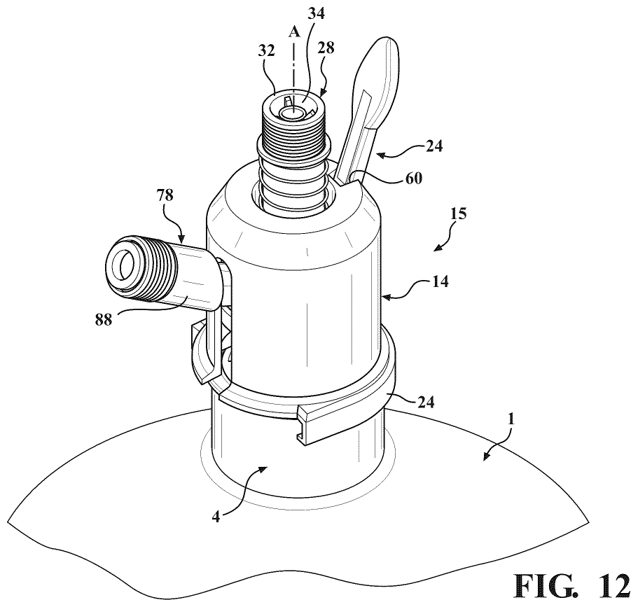

As best shown in FIG. 4, a coupler 24 is located at the bottom end 18 of the housing 14. The coupler 24 has a generally C-shaped cross-section along a plane that extends along the center axis A and extends approximately 180 degrees around the housing 14 such that it is configured to receive and be secured about the barnes neck 4 of the beverage keg 1. FIGS. 11-12 illustrate the housing 14 being laterally slid about the barnes neck 4 into a coupled position in which the keg 1 may be tapped.

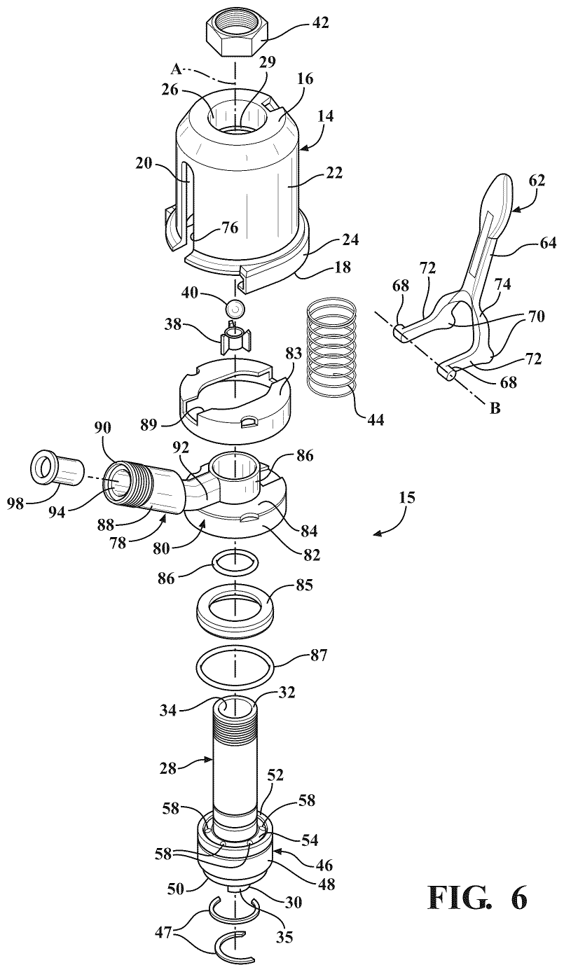

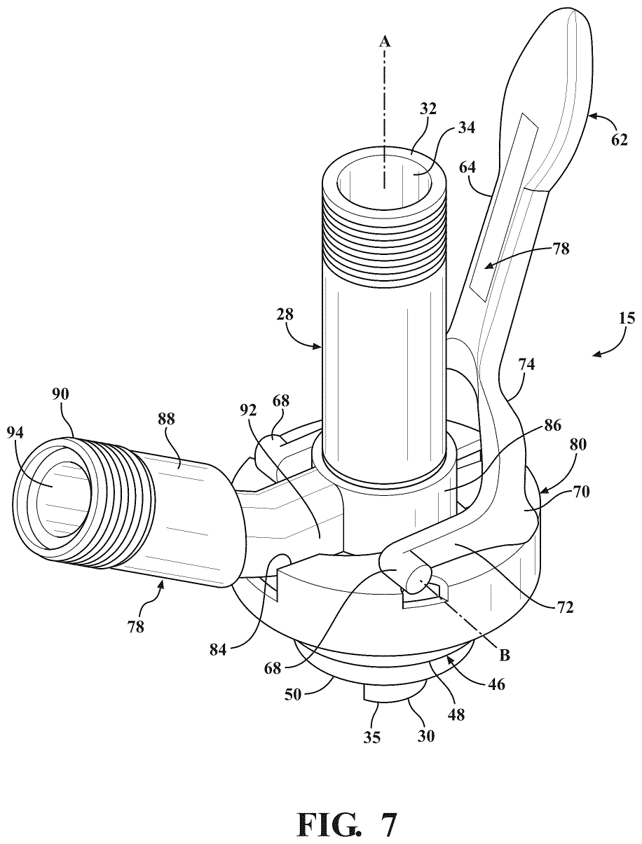

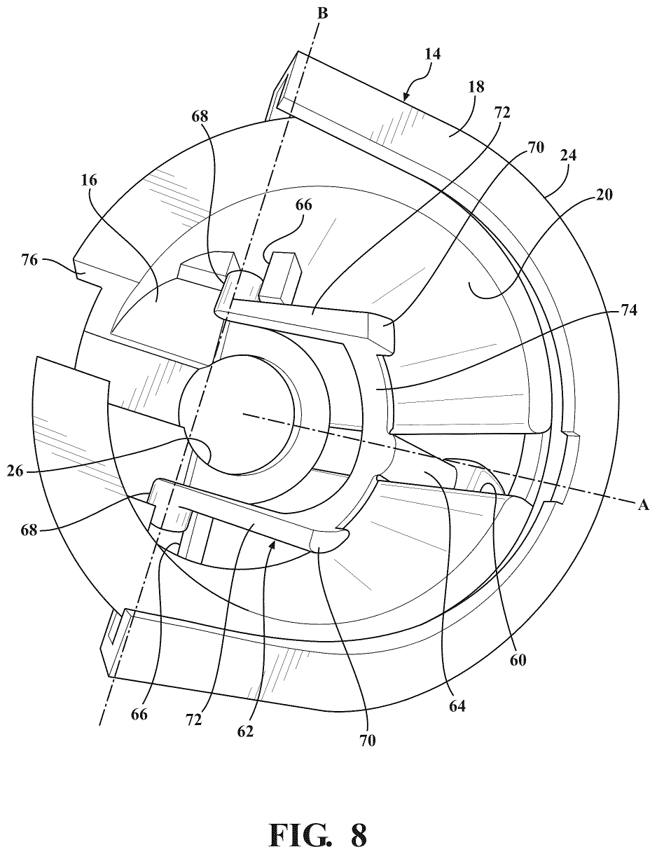

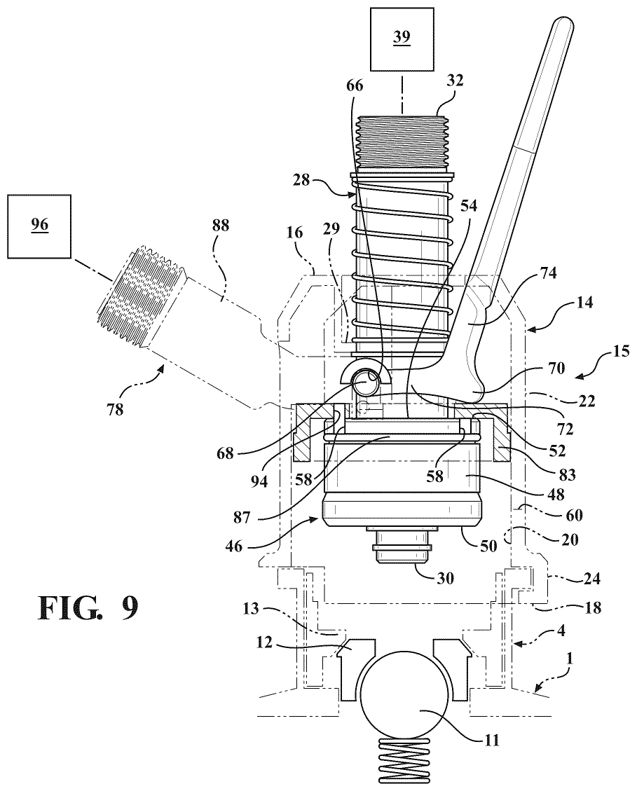

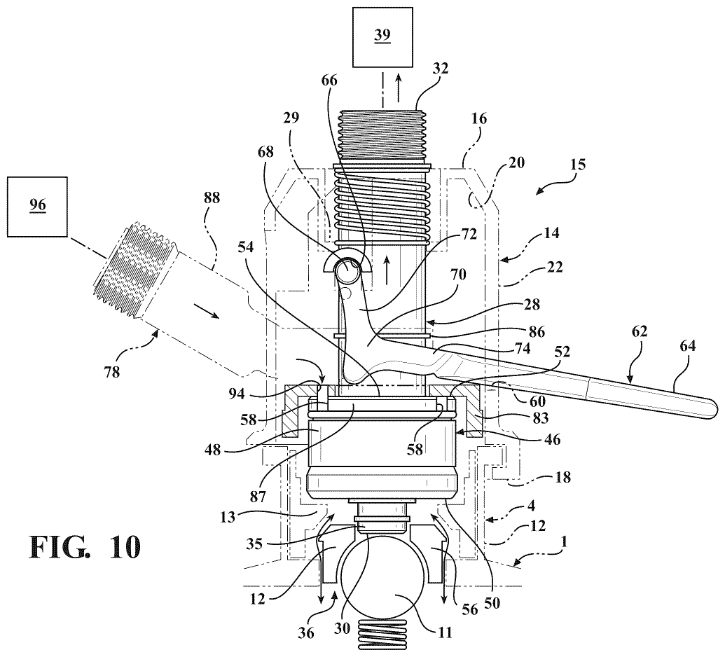

As best shown in FIGS. 4 and 6, the top end 16 of the housing 14 defines a probe passage 26 along the center axis A which is open to the chamber 20. A probe 28 is axially moveably received by the probe passage 26 and extends along the center axis A between a lower end 30 and an upper end 32. The probe 28 defines a beverage passage 34 that extends through the probe 28 along the center axis A. The probe 28 includes a pair of prongs 35 at the lower end 32 which are configured to engage and move a ball 11 of the keg valve 3 (shown in FIG. 11). As shown in FIGS. 9-10, when the dispensing valve assembly 15 is coupled to the barnes neck 4, the probe 28 moves axially between engaged and disengaged positions. In the engaged position (FIG. 10), the lower end 32 depresses the ball 11 and surrounding seal of the keg valve 3, allowing gas to flow from a supply of pressurized gas 96 through the assembly 15 into the beverage keg 1 and permitting the beverage to flow from the keg 1 through the assembly 15 to a tap 39. In the disengaged position (FIG. 9), the probe 28 is spaced from the keg valve 3, preventing gas from entering the keg 1 and preventing beverage from exiting the keg 1. The assembly 15 may be used with other keg valve configurations, such as where only the ball 11 is moveable.

As best shown in FIG. 6, a check valve seat 38 is located in the beverage passage 34 of the probe 28 adjacent to the upper end 32 of the probe 28. A ball 40 positioned on top of the check valve seat 38 for preventing a backflow of fluids into the keg 1 through the keg valve 3 while permitting the beverage to pass through the beverage passage 34 and to the tap 39.

The probe 28 is threaded near the upper end 32. A stopper 42 is threadedly connected to the upper end 32 of the probe 28. According to the shown embodiment, the stopper 42 is a nut 72 that is threadedly secured to the upper end 32 of the probe 28. A biasing element 44 like a spring 42 is disposed about the probe 28, and extends axially between the top end 16 of the housing 14 in a recess 29 and the stopper 42 to bias the probe 28 upwardly in the disengaged position.

An umbrella seal 46 is positioned about the probe 28 adjacent to the lower end 30 and within the chamber 20 of the housing 14. A pair of C-clips 47 are positioned about the probe 28 adjacent to the umbrella seal 46 for axially fixing the umbrella seal 46 in place. The umbrella seal 46 generally has a piston shape and has a sidewall 48 that extends between a ring-shaped downward end 50 and an upward end 52. A horizontal top wall 54 is located at the upward end 52. The downward end 50 is configured to sealingly engage the valve seat 13 of the keg valve 3 (shown in FIG. 10) when the probe 28 is in the engaged position. The top wall 54 of the umbrella seal 46 defines a plurality of passages 58 that extend axially through the umbrella seal 46 for dispensing a gas through the keg valve 3 into the beverage keg 1 (discussed in further detail below). Any number of the passages may be used 58. The umbrella seal 46 is configured to prevent spray of the beverage, especially during movement of the probe 28 between the engaged and disengaged positions. The umbrella seal 46 may be configured to prevent spray when used with other styles of keg valves.

As shown in FIGS. 11-12, the wall 22 of the housing 14 defines an axially-extending handle slot 60. A handle 62 has a lever 64 that extends through the handle slot 60 into the chamber 20 of the housing 14. As best shown in FIGS. 8-10, the handle 62 is pivotably connected to a bottom side of the top end 16 of the housing 14 along a pivot axis B that is perpendicular to the center axis A. More particularly, a pair of U-shaped receptacles 66 are located along the bottom side of the top end 16 of the housing 14 in the chamber 20 along the pivot axis B. The handle 62 further has a pair of pivot legs 68 aligned along the pivot axis B and each pivotably received in a respective one of the receptacles 66. The handle 62 further has a pair of engagement feet 70 that are spaced from the pivot legs 68 and positioned above the top wall 54 of the umbrella seal 46 and configured to axially move the umbrella seal 46 up and down between the disengaged position (FIG. 9) and the engaged position (FIG. 10) in response to pivoting of the handle 62 via the lever 64 by a user. The engagement feet 70 are located on opposite sides of the center axis B. The handle 62 further has a pair of connecting members 72 that each span linearly between a respective one of the pivot legs 68 and a respective one of the engagement feet 70. The handle 62 further has a generally U-shaped center member 74 that extends between each of the engagement feet 70 and the lever 64, upwardly relative to the connecting member 72 at an angle. The handle 62 may be configured to have other numbers of pivot legs 68 and engagement feet 70 to effectuate axial movement of the probe 28.

As best shown in FIGS. 4 and 6 and The wall 22 of the housing 14 further defines an axially extending air slot 76 at the bottom end 18 of the wall 22 on an axially opposite side of the housing 14 from the handle slot 60. An air intake assembly 78 is positioned about the probe 28 in the chamber 20 of the housing 14. The air intake assembly 78 includes a shell 80 disposed about the probe 28 and axially slideable in the chamber 20 with the probe 28. The shell 80 has a tube-shaped sidewall 82 and a top 84 that extends radially inwardly from the sidewall 82. The umbrella seal 46 is received by the sidewall 82. An annular spacer 85 is positioned inside and under the shell 80, radially between the shell 80 and the umbrella seal 46. An umbrella O-ring 87 is positioned about the umbrella seal 46 to seal between the umbrella seal 46 and the spacer 85. A cap 83 axially overlies the top 84 of the shell 80 and is slideable in the chamber 20 of the housing 14. The cap 83 defines a linear slot 89. A tube-shaped sleeve 86 extends upwardly from the top 84 of the shell 80, through the slot 89 of the cap 83, and about the probe 28. The engagement feet 70 of the handle 62 engage a top surface of the cap 83 during pivoting of the handle 62 to drive the umbrella seal 46 axially up and down, as shown in FIGS. 9-10. A probe O-ring 86 is positioned about the probe 28 adjacent to the lower end 30 of the probe 28 for sealing the space between the probe 28 and the sleeve 86.

The air intake assembly 78 further includes an air intake conduit 88 that is received by and axially slideable in the air slot 76. The air intake conduit 88 extends between an inlet end 90 outside of the housing 14, and an outlet end 92 that is coupled to the shell 80 in the chamber 20 of the housing 14 through the slot 89 of the cap 83. The air intake conduit 88 defines a gas passage 94 spanning between the inlet end 90 and the outlet end 92. As schematically shown in FIGS. 9-10, the inlet end 90 is connectable to the supply of compressed gas 96. An air sleeve 98 is positioned in the inlet end 90 of the air intake conduit 88 for facilitating a connection to an air line of the supply of compressed gas 96. The outlet end 92 connects to the top 84 of the shell 80, and the gas passage 94 communicates with the passages 58 of the umbrella seal 46 through the shell top. In operation, compressed gas from the supply 96 passes through the umbrella seal 46 and the keg valve 3 into the keg 1, pressurizing the keg and causing beverage to flow through the probe passage 26 when the probe is in the engaged position.

The dispensing valve assembly 15 efficiently extracts beverage from a well-style keg 1 while preventing sealing and leakage issues, notably while the dispensing valve assembly 15 is disconnected from the barnes neck 4. The design operates with existing kegs 1 and keg valves 13 without requiring modifications due to the arrangement of the coupler 24 about the barnes neck 4. The dispensing valve assembly 15 transitions smoothly between engaged and disengaged positions and is simple and inexpensive to assemble, notably due to the arrangement of the pivotable handle 62 which pivots relative to the receptacles 66 under the top end 16 of the housing 14.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in that particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or later, or intervening element or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to described various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in any embodiment, even if not specifically shown or described. The same may also be varied in many ways. Such variations are not to be regarded as a departure from the disclosure, and all such modifications are intended to be included within the scope of the disclosure.

What is claimed is:

1. A dispensing valve assembly for being coupled with a barnes neck of a beverage keg, comprising:
a housing extending about and along a center axis between a top end and a bottom end, and defining a chamber;
a coupler at the bottom end of the housing having a C-shaped cross-section at least partially around the bottom end of the housing for receiving the barnes neck of the beverage keg;
a probe in the chamber of the housing and moveable along the center axis relative to the housing;
an umbrella seal positioned about a bottom portion of the probe for creating a seal about the keg valve during use of the dispensing valve assembly and for preventing overspray during disengagement of the coupler from the keg; and
a handle extending into the chamber of the housing and pivotable relative to the housing about a pivot axis and having at least one engagement foot positioned above the umbrella seal for moving the probe and umbrella seal axially up and down between an engaged position and a disengaged position in response to pivoting of the handle, wherein the probe opens the keg valve when in the engaged position to permit the beverage in the keg to flow through the keg valve and to permit gas to flow into the keg, and wherein the probe is axially spaced from the keg valve when in the disengaged position to prevent the beverage in the keg to flow through the keg valve, and to prevent the gas from flowing into the keg.

2. The dispensing valve assembly as set forth in claim 1, wherein the at least one engagement foot includes a pair of engagement feet position on circumferentially opposite sides of the center axis.

3. The dispensing valve assembly as set forth in claim 2, wherein the housing has at least one receptacle in the chamber along the top end of the housing along the pivot axis, and wherein the handle further includes at least one pivot leg aligned along the pivot axis and pivotably received in the at least one receptacle of the housing.

4. The dispensing valve assembly as set forth in claim 3 wherein the at least one receptacle includes a pair of receptacles spaced from one another along the pivot axis, and wherein the at least one pivot leg includes a pair of pivot legs each pivotably received in one of the pair of receptacles of the housing.

5. The dispensing valve assembly as set forth in claim 4, wherein the housing has a wall extending between the top and bottom ends, wherein the wall defines a handle slot, wherein the handle further includes a lever connected to the engagement feet and extending through the handle slot for permitting a user to effectuate pivoting of the handle about the pivot axis.

6. The dispensing valve assembly as set forth in claim 5, wherein the handle includes a pair of connecting members each spanning between one of the pivot legs and one of the engagement feet, and wherein the housing includes a center member generally having a U-shape extending between each of the engagement feet and the lever.

7. The dispensing valve assembly as set forth in claim 1, wherein the top surface of the housing defines a probe passage along the axis, wherein the probe is received by the probe passage along the center axis, and wherein the probe is moveable along the center axis within the probe passage.

8. The dispensing valve assembly as set forth in claim 7, wherein the probe extends axially between a lower end and an upper end, wherein a stopper is located at the upper end, and wherein a spring is disposed about the probe and extends between the top end of the housing and the stopper to bias the probe in an axially upward direction.

9. The dispensing valve assembly as set forth in claim 1, wherein the probe is threaded adjacent to the upper end, and wherein the stopper is a nut being threadedly secured to the upper end of the probe to permit an operator to position the spring about the probe and axially secure the spring in place.

10. The dispensing assembly as set forth in claim 1, wherein the probe defines a beverage passage extending through the probe along the center axis for receiving the beverage from the keg when the probe is in the engaged position.

11. The dispensing assembly as set forth in claim 10, wherein the umbrella seal defines at least one air passage that extends through the umbrella seal in the direction of the center axis for dispensing a gas through the keg valve into the keg when the when the probe is in the engaged position.

12. The dispensing assembly as set forth in claim 10, wherein the at least one air passage includes a plurality of air passages circumferentially spaced from one another about the center axis.

13. The dispensing valve assembly as set forth in claim 12, wherein the wall of the housing further defines an air slot, wherein an air intake assembly includes an air intake conduit that is received by and axially slideable in the air slot, extending between an inlet end and an outlet end and defining a gas passage spanning between the inlet end and the outlet end, the air intake conduit connected to a supply of compressed gas at the inlet end, the air intake conduit connected to the probe adjacent to the umbrella seal at the outlet end, and wherein the gas passage of the air intake conduit is fluidly connected to the air passages of the umbrella seal to dispense gas from the compressed gas source through the gas passage and through the keg valve into the keg when the when the probe is in the engaged position.

14. The dispensing valve assembly as set forth in claim 13, wherein the air intake assembly further has a shell extending annularly about the probe and axially slideable in the chamber of the housing, the shell having an axial sidewall and a top extending radially inwardly from the sidewall and receiving the umbrella seal, the top of the shell defining a passage fluidly connected to the outlet end of the air intake conduit.

15. The dispensing valve assembly as set forth in claim 14, wherein an umbrella O-ring is positioned about the umbrella seal to seal between the umbrella seal and the sidewall of the shell.

16. The dispensing valve assembly as set forth in claim 14, wherein a cap axially overlies the top of the shell and is slideable in the chamber of the housing.

17. The dispensing valve assembly as set forth in claim 10, wherein a check valve seat is located in the beverage passage of the probe adjacent to the top end of the probe, and wherein a ball is positioned on top of the check valve seat in the beverage passage of the probe for preventing a backflow of fluids into the keg while permitting the beverage to pass out of the keg and through the beverage passage.

18. The dispensing valve assembly as set forth in claim 1 wherein the pivot axis is perpendicular to the center axis.

19. The dispensing valve assembly as set forth in claim 1, wherein the coupler at the bottom end of the housing extends approximately 180 degrees around the bottom end of the housing.
